(19) United States
(12) Patent Application Publication
(10) Pub. No.: US 2018/0108243 A1
(43) Pub. Date: Apr. 19, 2018

(54) PROXIMITY-BASED REMINDER SYSTEM AND APPLICATION

(71) Applicant: Austin Scherer, New York, NY (US)

(72) Inventor: Austin Scherer, New York, NY (US)

(21) Appl. No.: 15/787,258

(22) Filed: Oct. 18, 2017

Related U.S. Application Data
(60) Provisional application No. 62/409,734, filed on Oct. 18, 2016.

(51) Int. Cl. G08B 21/24; H04M 1/725; H04W 4/02; G06F 3/0482

(52) U.S. Cl. CPC G08B 21/24; H04M 1/72572; G06F 3/0482; H04W 4/02; H04M 1/72569

(57) ABSTRACT

A mobile application for a proximity-based reminder system that monitors a user's location along with the user's proximity to their personal belongings, and reminds the user when they are at risk of leaving a predetermined area without taking those personal belongings with them. The user is able to create a reminder/alert by choosing a personal item, and then selecting a distance or area such that they cannot cross without receiving an alarm/notification. The proximity-based reminder system dynamically tracks, maps and calculates the user's location and movement data, and compares the user's dynamic location with their initial location, to determine when the user has moved or traveled beyond their selected distance or area. When this condition is met, the user is presented with an alarm or push notification reminding the user not to leave the area without bringing their personal items with them.

### BACKGROUND

### Technical Field

The present disclosure, in general, relates to location-aware reminder services. More particularly, this disclosure relates to reminding/alerting a user when they have traveled a pre-determined distance away from their personal belongings.

### Description of Related Art

The proliferation of distractions in our increasingly complicated world, coupled with the continued growth of personal belongings that accompany us on a day to day basis (e.g. mobile phones, tablets, watches, headphones, laptops, wallets, keys, etc.), has further complicated our efforts to remember to take all of our items with us as we travel from location to location.

As a result, we are more likely than ever to forget personal items and leave them behind. This has very real and meaningful consequences, both in terms of money lost (i.e. the value of our items), and in terms of time lost (i.e. the time spend looking for the items).

To solve this growing issue, there is an increased need for a reminder service that keeps track of our personal belongings and, taking into account our movement and location, reminds us not to forget those personal belongings.

Conventional solutions to this problem incorporate supplemental hardware which must be added or attached to our personal belongings in order for the reminder services to work. These solutions suffer from a number of issues, including, but not limited to, scalability (a separate and dedicated tracking device/beacon must be attached to each personal item to be tracked), cost (individual tracking devices/beacons are costly), convenience (tracking devices/beacons are often larger and more cumbersome than the personal item it is intended to track), and complexity (each separate tracking device/beacon must be programmed and assigned to an individual personal item).

Alternative solutions to this problem may include the use of traditional app-based reminders that are created through use of a smartphone, tablet or other mobile device. These solutions are inherently flawed, because while these types of conventional reminder services are capable of notifying/reminding the user when they ARRIVE at or near a location, or notifying/reminding the user at a certain time of the day, there is a lack of reminder services that can notify the user when they LEAVE a location. For this reason, using conventional app-based or smartphone-based reminder services to prevent the user from leaving a location without their personal belongings is currently not feasible.

Therefore, there is a long existing, but previously unresolved, need for a computer implemented method and system that requires no additional hardware, and simply and conveniently monitors a user's location and proximity to their personal belongings, and reminds them when they are at risk of leaving these personal belongings behind. Consumers are increasingly using mobile devices such as smartphones, tablet computing devices, personal digital assistants, other handheld devices, etc. for performing many personal, work and business related tasks, so it makes sense for the embodiment of this disclosure to be exemplified via a mobile app.

### SUMMARY OF THE DISCLOSURE

The present disclosure is directed to a proximity-based reminder system and a method including steps of receiving a first user input identifying one or more items, receiving a second user input identifying a location of the one or more items, and receiving a third user input identifying a proximity threshold, represented as a maximum allowable travel distance between the location of the one or more items and a location of a mobile device. The method further includes determining the location of the mobile device, periodically calculating a distance between the location of the one or more items and the location of the mobile device, comparing the proximity threshold to the calculated distance between the location of the one or more items and the location of the mobile device, determining, based on the comparison of the proximity threshold and the calculated distance, when the mobile device has traveled beyond the proximity threshold, and generating a reminder when the mobile device has traveled beyond the proximity threshold.

In accordance with the method receiving the first user input may include generating an interface with a predetermined list of items, and allowing the user to select the one or more items from the interface with the predetermined list of items. The list of items may be generated based on preferences set by the user. Or the list of items may be generated based on the user's prior interaction with the list of items. The list of items may include items that have been added to the list of items by the user. An items added to the list of items by the user may include a title or description. Further the items that have been added to the list of items by the user may be visually customizable by the user.

In accordance with a further aspect of the disclosure receiving the second user input identifying the location of the one or more items includes receiving a starting location data point. And may further include determining which of a plurality of location services on the mobile device has the most accurate location information. Additionally or alternatively the method may include switching between a plurality of location services on the mobile device, depending on an availability and reliability of data, to select a location service among the plurality of location services. The method may also include cataloging item names of the one or more items and starting location data points of the one or more items. The cataloging the item names of the one or more items and starting location data points of the one or more items includes storing the item names and starting location data points on the mobile device. Cataloging may also include displaying the item names and starting location data points on the mobile device.

In accordance with a further aspect of the disclosure, determining the location of the mobile device includes receiving, from the mobile device, location data. Determining the location of the mobile device may include determining which of the plurality of location services on the mobile device has the most accurate location information. Determining the location of the mobile device includes switching between a plurality of location services on the mobile device, depending on the availability and reliability of data provided by each of the plurality of location services.

In accordance with a further aspect of the disclosure, the method includes establishing a virtual boundary around the one or more items based on the proximity threshold. Additionally or alternatively, the process of identifying a proximity threshold includes allowing the user to choose a value that represents how far the user can travel away from the one or more items before the reminder is generated.

Further, in accordance with the present disclosure, periodically calculating the distance between the location of the one or more items and the location of the mobile device includes periodically determining the differences in location between those locations. Periodically calculating the distance between the location of the one or more items and the location of the mobile device may include switching between a plurality of movement and location tracking services to determine distance traveled. Additionally or alternatively, periodically calculating the distance between the location of the one or more items and the location of the mobile device may include converting data generated by a plurality of movement and location tracking services to determine distance traveled. Further periodically calculating the distance between the location of the one or more items and the location of the mobile device may include determining a rate of travel and differentiating between different states of movement.

In a further aspect of the disclosure comparing the proximity threshold to the calculated distance between the location of the one or more items and the location of the mobile device includes periodically monitoring movement and location data of the mobile device. The comparing the proximity threshold to the calculated distance between the location of the one or more items and the location of the mobile device may include switching between a plurality of movement and location tracking services to determine distance traveled. Additionally or alternatively the comparing the proximity threshold to the calculated distance between the location of the one or more items and the location of the mobile device may include converting data between a plurality of movement and location tracking services to determine distance traveled.

In yet a further aspect of the disclosure determining when the mobile device has traveled beyond the proximity threshold includes periodically calculating the distance between the location of the one or more items and the location of the mobile device, and comparing that calculated distance to the distance of the proximity threshold, such that if the calculated distance is greater than the distance of the proximity threshold, the mobile device is determined to have traveled beyond the proximity threshold. Upon determining the mobile device has traveled beyond the proximity threshold, pausing one or more of periodically calculating the distance between the location of the one or more items and the location of the mobile device, comparing the proximity threshold to the calculated distance between the location of the one or more user's items and the location of the mobile device, and determining when the mobile device has traveled beyond the proximity threshold in order to preserve battery life of the mobile device. Further when the mobile device has traveled beyond the proximity threshold, the method may terminate one or more of the steps of periodically calculating the distance between the location of the one or more items and the location of the mobile device, comparing the proximity threshold to the calculated distance between the location of the one or more user's items and the location of the mobile device, and determining when the mobile device has traveled beyond the proximity threshold in order to preserve battery life of the mobile device. Further, when the mobile device has traveled beyond the proximity threshold, the method may generate a visual interface to inform the user of the calculated distance between the location of the one or more items and the location of the mobile device.

Still further generating a reminder when the mobile device has traveled beyond the proximity threshold may include presenting the user with a visual notification to remind them not to forget the one or more items. The reminder when the mobile device has traveled beyond the proximity threshold may also include presenting the user with an audio notification to remind them not to forget the one or more items. Still further the generating a reminder notification when the mobile device has traveled beyond the proximity threshold may include presenting the user with a tactile notification to remind them not to forget the one or more items. Moreover, the generating a reminder notification when the mobile device has traveled beyond the proximity threshold may include displaying a visual interface for the user to view user-generated notes about the reminder. And generating a reminder notification when the mobile device has traveled beyond the proximity threshold may include displaying a visual interface whereby the user can increase the proximity threshold, thereby resetting the reminder.

### BRIEF DESCRIPTION OF THE DRAWINGS

The foregoing summary, as well as the following detailed description of the disclosure, is better understood when read in conjunction with the appended drawings. For the purpose of illustrating the disclosure, exemplary embodiments are shown in the drawings. However, the disclosure is not limited to the specific methods and components disclosed herein.

FIG. 1 illustrates a mobile application implemented method for a proximity-based reminder system that simply, conveniently and dynamically monitors a user's location and proximity to their personal belongings, and reminds the user when they are at risk of leaving these personal belongings behind.

FIG. 2 exemplarily illustrates a flow chart comprising the steps performed by the proximity-based reminder system, in order to remind the user about a personal item they don't want to leave behind at their current location.

FIG. 3 exemplarily illustrates screenshots showing the steps performed in the process of creating a reminder/alert using the proximity-based reminder system.

FIG. 4 exemplarily illustrates the “Add New Item” interface, featuring a graphical interface whereby the user can add a custom or personalized item to the default list/library of personal items.

FIG. 5 exemplarily illustrates the “Search” interface that allows the user to quickly find default and custom items in the list/library of personal items.

FIG. 6 exemplarily illustrates the “History” interface that catalogs and displays the personal items the user has previously created reminders/alerts for.

### DETAILED DESCRIPTION OF THE DISCLOSURE

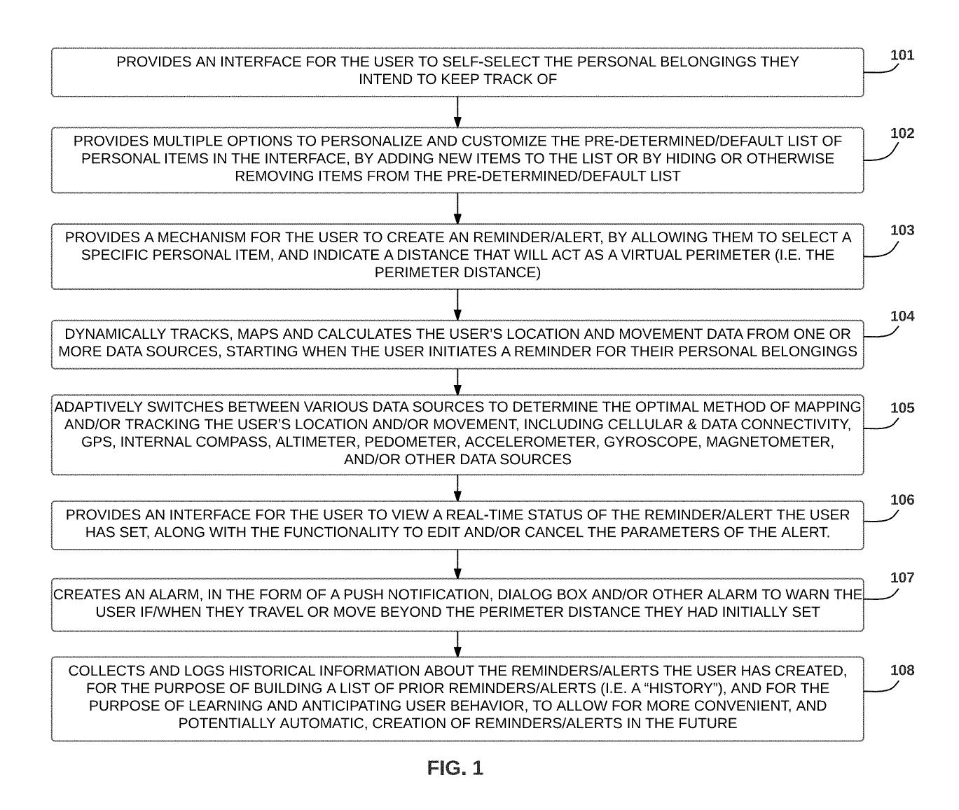

FIG. 1 illustrates a mobile application implemented method for a proximity-based reminder system that simply, conveniently and dynamically monitors a user's location and proximity to their personal belongings, and reminds the user when they are at risk of leaving these personal belongings behind. The mobile application implemented proximity-based reminder system disclosed herein provides, at step 101, an interface for the user to self-select the personal belongings they intend to keep track of—for the purpose of remembering to take these items with them when they leave their current location. The graphical interface includes a list/library of items for the user to choose from. The list/library is initially pre-determined and defaulted for the convenience of the user—and includes items that are commonly forgotten or left behind (e.g. eyeglasses, keys, wallet, watch, etc.), items that an individual might need to remember depending on their specific situation (e.g. passport, movie tickets, child, pet, etc.), and other personal items that may be of use for the user. The pre-determined list/library may be represented as a list, matrix, grid or similarly arranged items and corresponding icons representing these items—this allows the user to easily and conveniently view the list/library to quickly find the item they are looking for.

The proximity-based reminder system disclosed herein provides 102 multiple options to personalize and customize the pre-determined/default list/library of personal items in the interface, by adding new items to the list/library or by hiding or otherwise removing items from the pre-determined/default list/library. In an embodiment, the interface allows for the user to temporarily or permanently remove or hide one or more of the items from the pre-determined/default list/library. This allows the user to eliminate any items that are either irrelevant or unnecessary for them. The purpose of customizing this list/library is to best reflect the personal items the user owns allowing them to keep track of those specific, personal items. For example, if the user does not have a dog or cat, they are able to remove or hide the item “Dog” or “Cat” (or both) from the default list/library.

In another embodiment, the proximity-based reminder system provides an interface for the user to add additional/custom items to the pre-determined/default list/library of personal items included within the system. As one example, if the user wants to be reminded about a personal belonging that is not included in the default list/library (e.g. a unique or uncommon item such as a typewriter), the user is able to add any new item to the list/library of personal belongings within the interface, and this item will be included in the list/library of personal items to choose from until such time the user decides to delete this item from the list/library of available personal belongings (if they so wish). Further, in addition to allowing the user to name or describe their newly added/custom item, the interface allows the user to indicate a custom color to associate with the item (e.g. via a colored border, a colored bar to adorn the item's name, a custom icon, or similar). This customization allows for personalization of the items they add to the list/library, and to allow for quicker visual recognition of their items amongst the default list/library of items.

The proximity-based reminder system disclosed herein provides, at step 103, a mechanism for the user to create a reminder/alert, by allowing them to select a specific personal item, and indicate a distance that will act as a virtual perimeter (i.e. the Perimeter Distance)—in essence limiting their travel or movement away from the selected item by reminding/alerting the user if/when they have left this virtual perimeter—thereby reducing their risk of forgetting the item and leaving it behind. The user is able to select the specific personal item from the list/library of pre-determined/default items in the aforementioned interface, or the user is able to select one of the custom items they have added to the pre-determined/default list/library of items, or the user is able to add a new custom item at the time they wish to create the reminder/alert. Additionally, the user is able to select a generic item (e.g. a “quick alert” or similar) for the purposes of setting a reminder/alert more quickly—for example, if the user wants to create a reminder/alert, but does not have the time to search or browse the list/library of personal items.

In an embodiment, when the user initiates the proximity-based reminder system and begins the process of establishing a reminder/alert about a personal item they do not want to forget or leave a location without, the proximity-based reminder system acquires information about the location of the user (based on numerous data sources gathered from their mobile device), and the system uses this information to establish an Origin Location (also based on numerous data sources gathered from their mobile device). The system then begins to map the user's movements and/or dynamically changing location and subsequently compares that movement and/or location data in order to calculate the distance and/or movement between the Origin Location and the Perimeter Distance set by the user in order to determine if and when to trigger the alarm to remind the user to take their personal item with them. As used herein, the term “Origin Location” refers to the initial reference point or location of a user's personal item(s), as measured by geographical location data acquired through their mobile device's data (e.g. GPS location, cellular tower information, Wi-Fi positioning and/or other data sources) or by the creation of a referential starting point from which any further movement is tracked, measured and converted to approximate distance traveled (e.g. using data gathered and calculated using the mobile device's internal compass, altimeter, pedometer, accelerometer, gyroscope, magnetometer, and/or other data sources). Also, as used herein, the term “Perimeter Distance” refers to a user-defined or default distance, measured from the Origin Location—represented by linear distance (e.g. feet/meters), referential distance (e.g. block or building sized units), units of measure based on step count, or units of measure based on another data collection method—that represents the invisible perimeter created around the personal item at the Origin Location, whereby when the user travels or moves beyond that Perimeter Distance, an alarm or notification is triggered to remind the user not to leave the area without their personal items.

The proximity-based reminder system disclosed herein dynamically, at step 104, tracks, maps, and calculates the user's location and movement data from one or more data sources, starting when the user initiates a reminder for their personal belongings. In an embodiment, the proximity-based reminder system continually monitors and tracks the user's current location and/or movement (based on the location/movement of the user's mobile device) in order to determine the user's location as it relates to the Origin Location, so as to trigger a reminder/alert (in the form of an alarm, push notification or other type of notification) to warn the user when they have traveled or moved past the Perimeter Distance for the purpose of reminding them to bring their personal belongings with them as they leave.

The proximity-based reminder system disclosed herein adaptively, at step 105, switches between various data sources to determine the optimal method of mapping and/or tracking the user's location and/or movement, including cellular and data connectivity, GPS, internal compass, altimeter, pedometer, accelerometer, gyroscope, magnetometer, and/or other data sources. In an embodiment, the proximity-based reminder system seamlessly switches between, and combines data from, various location and movement tracking protocols without the involvement or interaction of the user. This allows the proximity-based reminder system to most accurately track the user's movement away from their personal items, regardless of the availability or strength of Wi-Fi connectivity, cellular, data or GPS signal, and regardless of whether the user is walking, running, driving or otherwise traveling.

The proximity-based reminder system disclosed herein provides 106 an interface for the user to view a real-time status of the reminder/alert the user has set, along with the functionality to edit and/or cancel the parameters of the reminder/alert. In an embodiment, the proximity-based reminder system allows the user to view the status of their reminders/alerts and see, in real-time, the comparison between the Perimeter Distance they've set and the distance they've traveled in relation to their personal belongings (represented in linear distance, via step count, or another visual, numerical, or graphical representation). Further, the proximity-based reminder system allows the user to edit or adjust the reminder/alert, by way of increasing or decreasing their Perimeter Distance, or to cancel the reminder/alert altogether. Additionally, the proximity-based reminder system provides an option for the user to add free-form text notes that will be appended to the reminder/alert notification text when the Perimeter Distance is breached and the alarm is triggered. For example, the user can add a note to their reminder/alert that includes the information from their coat check tag, so that, in addition to being reminded about taking their coat when they leave a location, they are reminded about what number was on their coat check tag. In another example, the user can add a note to their reminder that indicates that their passport is on their nightstand, so that, in addition to being reminded to bring their passport before they leave their house, they are reminded about the specific location of their passport.

The proximity-based reminder system disclosed herein creates 107 an alarm, in the form of a push notification, dialog box and/or other alarm to warn the user if/when they travel beyond the Perimeter Distance they had initially set, therefore indicating that the user has walked, traveled or otherwise moved away from their personal belongings beyond the allowable measure of distance or movement based on the parameters set forth during the initial creation of the reminder/alert. For example, if the user initially set a reminder/alert for the system to alarm them if/when they walk more than 40 feet away from their backpack, and provided the proximity-based reminder system has calculated that the user has walked more than 40 feet away from their backpack (by way of collecting and assessing the user's mobile device location and movement as described previously), the proximity-based reminder system will send the user an alarm to remind them not to forget their backpack.

The sound and vibration pattern of the reminder/alert will be a chosen by default for the user, although the user has the option to select a personalized reminder/alert sound and vibration pattern from an included interface that allows the user to customize the audible and tactile aspects of their reminders/alerts, by way of choosing from a library of alarm sounds and vibration patterns. In an embodiment, this customization will allow the user to more easily distinguish between an alarm from the proximity-based reminder system, and an alarm from another source (for example to distinguish an alarm from the proximity-based reminder system vs. an email alarm).

In addition to the notification message, and the sound and vibration alert, when the proximity-based reminder is triggered, the user will also be presented with the free-form text notes that they included during the creation of the reminder/alert (assuming that they utilized this optional feature). In an embodiment, the proximity-based reminder system will present the user's notes along with the reminder/alert notification, so as to provide the user with more contexts about their personal belongings at the time of the alarm.

Additionally, when the reminder/alert is triggered, the user is presented with several options that will allow them to dismiss or modify the reminder/alert. In an embodiment, the user will be presented with several options that will allow them to choose to dismiss the reminder/alert (therefore instructing the proximity-based reminder system to end its tracking of the user's movement for this particular personal item), extend the coverage area of the reminder/alert (therefore allowing the user to increase the distance they can travel away from their personal item, and in effect instructing the proximity-based reminder system to reconfigure and recalculate the new, wider Perimeter Distance and restart the process of tracking the user's distance and movement and ultimately triggering another alarm as previously explained), or temporarily suspend the reminder/alert and location/movement tracking until the user returns to the Origin Location or the area within the Perimeter Distance (therefore allowing the user to temporarily travel beyond the Perimeter Distance with the understanding that they will return to the Origin Location, or the area within the Perimeter Distance).

In this last scenario (where the user selects the option to temporarily suspend the reminder/alert), the proximity-based reminder system will continue to track and map the travel and movement of the user (based on the travel and movement of their mobile device) and will determine when the user has traveled back to the Origin Location, or the area within the Perimeter Distance. When the user is within the Perimeter Distance, the proximity-based reminder system will automatically resume tracking and mapping the location and movement of the user for the purposes of determining if/when the user again travels beyond the Perimeter Distance—therefore reminding them again when they are at risk of leaving the area without their personal belongings.

To provide an example of this scenario, if the user sets a reminder/alert to prevent them from walking more than 40 feet away from a meeting room without their laptop, but during the meeting the user temporarily leaves the meeting room to use the lavatory or to get a cup of coffee (i.e. therefore traveling outside of the 40-foot Perimeter Distance set by the user), the proximity-based reminder system will send the user an alarm when they initially travel outside the 40-foot radius, but if the user chooses the option to suspend the reminder/alert, the proximity-based reminder system will reset the reminder/alert and will determine if/when the user returns back to the area within the Perimeter Distance (i.e. once they return to the meeting room from the lavatory or from getting a cup of coffee), and then the proximity-based reminder system will alert/remind the user when they subsequently leave the Perimeter Distance again (e.g. when they are leaving the meeting room at the conclusion of the meeting).

As a note, after suspending the reminder/alert, if the user does not return to the area within the Perimeter Distance for an extended period of time (e.g. 4 hours), the proximity-based reminder system will prompt the user (via push notification, dialog box or similar) to confirm whether or not the location/movement tracking should continue. For example, if the user suspends the reminder/alert when they think they are leaving the meeting room temporarily, but their situation changes and they no longer plan to return to the meeting room, after an extended period of time (e.g. 4 hours) the proximity-based reminder system will confirm if the user still will be returning to the meeting room—therefore limiting the proximity-based reminder system's impact on the user's mobile phone battery, and also reminding them not to forget the personal item they initially set the reminder/alert for.

The proximity-based reminder system disclosed herein collects 108 and logs historical information about the reminders/alerts the user has created, for the purpose of building a list of prior reminders/alerts (i.e. a “history”), and for the purpose of learning and anticipating user behavior, to allow for more convenient, and potentially automatic, creation of reminders/alerts in the future. Regarding the list of prior reminders/alerts (i.e. a “history”), data logged and presented to the user in this “history” list may include: the name and icon of the personal item, the time and day the reminder/alert was created, the address or location of where the reminder/alert was created (i.e. the Origin Location), and other data exclusively viewable by the user (i.e. stored locally on the user's mobile device and not sent or stored remotely). In an embodiment, the proximity-based reminder system will catalog and output a list (along with relevant details, including but not limited to the time, day and date of reminder/alert creation, and Origin Location) of personal belongings the user has created reminders/alerts for, to allow the user to easily retrieve their lost items in the event they leave a location without bring their personal belongings with them, or for historical tracking information for the user. For example, if the user leaves a location where they created a reminder/alert—without their personal belongings—they are able to utilize the “history” list to see where they created the reminder/alert, and therefore where the personal item should be. In addition to including the list of relevant information about the user's prior reminders/alerts, the user is also able to see a map view of the Origin Location of each reminder/alert created, so as to make it easier to return to the Origin Location if necessary. The interface for displaying the user's prior reminders/alerts (i.e. historical information) also allows the user to delete or remove one or more (or all) of the prior reminders/alerts.

Regarding the proximity-based reminder system's ability to learn and anticipate user behavior, to allow for more convenient, and potentially automatic, creation of reminders/alerts in the future, in an embodiment, the proximity-based reminder system will evaluate background location data (collected from GPS location, cellular tower information, Wi-Fi positioning and/or other data sources), and when it encounters a scenario where the user is currently in a location where they have previously created a reminder/alert about their personal belongings, the proximity-based reminder system will anticipate the user's potential desire to create a new reminder/alert and prompt the user with a push notification or other notification allowing them to easily create a reminder/alert. For example, if the user has previously used the proximity-based reminder system to create a reminder/alert about their laptop while at a particular café, the next time they are at that same café, the proximity-based reminder system will send the user a push notification asking if they want to create a new reminder/alert.

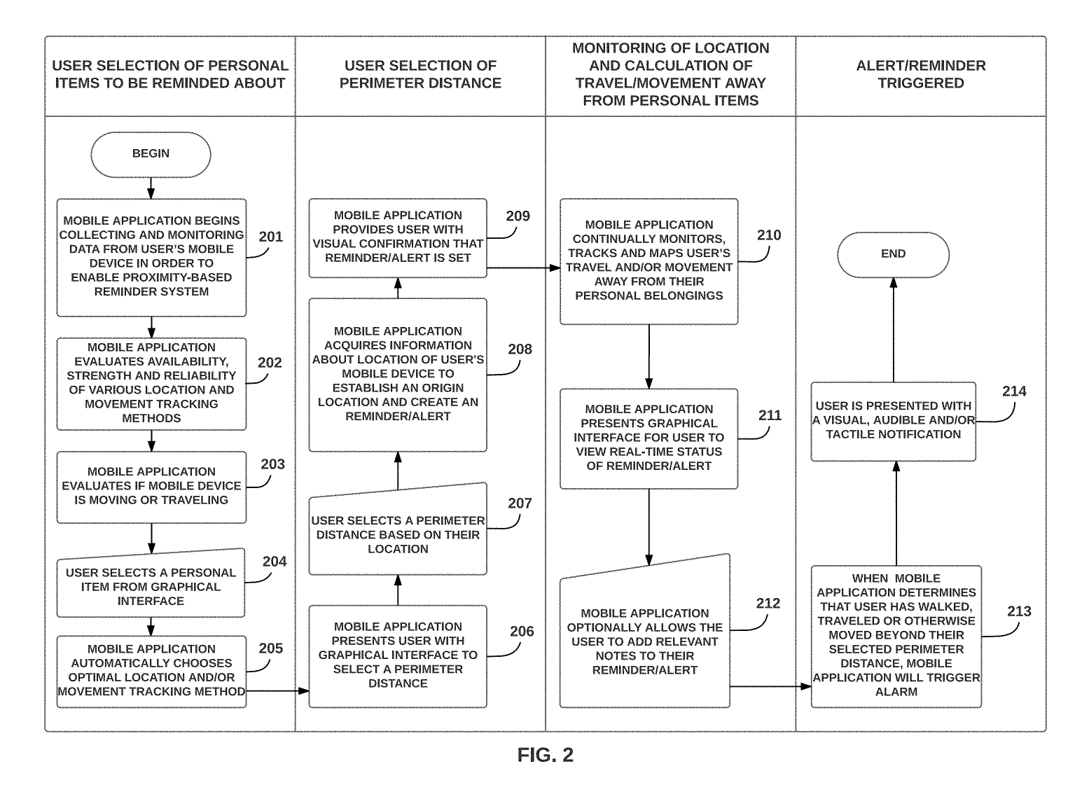

FIG. 2 exemplarily illustrates a flow chart comprising the steps performed by the proximity-based reminder system, in order to remind the user about a personal item they don't want to leave behind at their current location. When the user initiates the mobile application implemented method for a proximity-based reminder system, the mobile application 201 begins collecting and monitoring data from the user's mobile device in order to enable the proximity-based reminder system (e.g. location information, cellular and GPS signal strength, proximity to Wi-Fi base stations and other data). Additionally, the mobile application 202 evaluates the availability, strength and reliability of various location and movement tracking methods (e.g. location services provided by the operating system of the mobile device, GPS, Wi-Fi positioning, internal compass, altimeter, pedometer, accelerometer, gyroscope, magnetometer, and/or other data sources). Also, the mobile application 203 evaluates if the mobile device is moving or traveling in such a way that would reduce or diminish the accuracy of one or more location or movement tracking methods (e.g. at accelerated speeds, in a train, car, etc.). Meanwhile, the user 204 selects a personal item from the graphical interface for the proximity-based reminder system to remind them not to forget or leave at their current location. Based on all data and information evaluated by the mobile application from the previous steps and processes, the mobile application 205 automatically chooses the optimal location and/or movement tracking method for monitoring and tracking the user's movement away from their personal items. Depending on the data and information evaluated in the previous steps, the mobile application may use one or more data sources in sequence, in combination or otherwise in order to track the user's movement or travel away from their personal belongings. For example, if the mobile application determines that GPS location data is weak or unavailable, the mobile application may choose to use Wi-Fi positioning and/or pedometer data instead. In another example, if GPS is strong but then becomes weak or nonexistent at any point in the overall process, the mobile application may dynamically switch from GPS to another location or movement tracking mechanism automatically and in real-time. In another example, because the proximity-based reminder system acquires data about the movement of the user's mobile device, and can differentiate between different states of movement, including standing still, walking, running, driving, and other states of movement, if the mobile application determines that the user's mobile device is traveling in excess of a certain speed (e.g. above 60 miles per hour), the mobile application may assume the user is traveling in a car, train, bus or otherwise, and therefore avoid the use of GPS location tracking, in favor of other data sources that would allow the proximity-based reminder system to track and monitor the user's movement away from their personal items while in the car, train, bus or otherwise. Additionally, the mobile application may use information and data evaluated in the previous steps to impact internal decisions made by the mobile application in future steps and processes. For example, if the mobile application determines that the user's mobile device is traveling at a speed indicative of walking or running, the mobile application may use this information to impact the creation of the Origin Location, to be explained in later processes.

After choosing the optimal location and/or movement tracking method, the mobile application 206 presents the user with a graphical interface to select their Perimeter Distance. The graphical interface presented to the user may be specific to the location and movement tracking method automatically chosen by the system. For example, the interface the user sees when the system is tracking location and movement based on GPS may be different from the interface the user sees when the system is tracking location and movement based on other data sources. The graphical interface will present the user with various perimeter options, and may represent perimeter distance for the user based on linear distance (e.g. 20 feet, 30 feet, etc.), step count (e.g. 40 steps, 60 steps, etc.), figurative distance (e.g. an area the size of a room, an area the size of a city block, etc.), or another representation of perimeter distance. From this graphical interface, the user 207 selects a Perimeter Distance based on their location and their desire to be reminded about their personal items before walking or otherwise traveling a specific distance away from their personal items. For example, if the user is in a small room (e.g. café, bar, etc.), they may select a small distance or perimeter area that corresponds with that location (e.g. 30 feet, 60 steps or “room”—based on the examples provided previously). Once the user has made their selection, and therefore chooses a Perimeter Distance, the mobile application 208 acquires information about the location of the user to establish an Origin Location and create a reminder/alert. As referenced earlier, because the proximity-based reminder system acquires data about the movement of the user's mobile device, and can differentiate between different states of movement—including standing still, walking, running, driving, and other states of movement—if the system determines that the user is walking or running or otherwise in transit, the proximity-based reminder system may optionally allow the user to create a reminder/alert while they are walking or running or otherwise in transit to the Origin Location, and the system will automatically suspend the placement of the Origin Location until the user is no longer walking, running or otherwise in transit. In an embodiment, the proximity-based reminder system allows the user to create a reminder/alert while they are traveling to/on the way to a meeting (for example), and the system will automatically wait to create the Origin Location until the user is at the meeting (i.e. based on the system knowing that the user has stopped their movement for a pre-determined amount of time).

To conclude the creation of the reminder/alert, the mobile application 209 provides the user with a visual confirmation (e.g. push notification, dialog box or similar) to inform them that the reminder/alert has been activated.

Now that the proximity-based reminder system has identified a Perimeter Distance and an Origin Location, the mobile application 210 continually monitors, tracks and maps the user's travel and/or movement away from their personal belongings, as defined by the difference between the user's mobile device's Origin Location and the user's selected Perimeter Distance. The system utilizes a variety of internal and external data sources to determine and measure the user's movement and/or location (e.g. location services within the mobile device's operating system, GPS, cellular and data connectivity, Wi-Fi positioning, pedometer, and other data sources), and may utilize multiple data sources independently, in combination or comparatively. Further, the system will switch seamlessly between data sources without the input or awareness of the user. Meanwhile, the mobile application 211 presents a graphical interface for the user to view a real-time status of their reminder/alert. This status may include information such as the item name and graphical representation (e.g. icon) of the personal item they initially selected to initiate the reminder/alert, the Perimeter Distance they initially set (represented by linear distance [e.g. 20 feet, 30 feet, etc.], step count [e.g. 40 steps, 60 steps, etc.], figurative distance [e.g. an area the size of a room, an area the size of a city block, etc.], or another representation of perimeter distance), and the dynamically generated difference between the user's mobile device's Origin Location and the user's selected Perimeter Distance (represented by linear distance, step count, figurative distance or another representation of distance). The interface that displays the status for the reminder/alert may also have additional data relevant to the user's reminder/alert, and may also allow the user a mechanism to cancel or modify the reminder/alert. Additionally, the mobile application 212 optionally allows the user to add relevant notes to their reminder/alert to improve the value of the reminder/alert. For example, if the user is utilizing the proximity-based reminder system to create a reminder/alert so they do not leave their house without taking their car keys, they can add a custom note to the reminder/alert with specific information about the location of their car keys (e.g. “kitchen counter”). The note(s) the user adds will be appended to the reminder/alert notification to provide them contextually relevant information when they intend to retrieve their personal belongings.

When the mobile application 213 determines that the user has walked, traveled or otherwise moved beyond their selected Perimeter Distance, the mobile application will trigger an alarm to remind the user to bring their personal belongings with them as they leave their location. The mobile application will make this determination about the user walking, moving or otherwise traveling beyond the Perimeter Distance based on the dynamic analysis of multiple data sources from the user's mobile device, and by calculating and difference between the user's mobile device's Origin Location and the user's selected Perimeter Distance, as described previously. When the mobile application triggers an alarm, the user is 214 presented with a visual, audible and tactile notification (e.g. a push notification and/or dialog box along with an alarm tone and vibration). In addition to displaying text and/or imagery (e.g. icons) to remind the user about the personal item they initially created the alert for, the notification will present the user with the notes they opted to append to the alarm during a previous 212 step (if applicable). The user is additionally presented with several options on how to respond to the alarm. The user can choose to cancel the alarm (i.e. to end the process), or the user can choose to extend the Perimeter Distance by a set or custom value of distance or movement (thereby instructing the system to continue to dynamically map and track the user's mobile device's location and movement, and to continue to calculate the difference between the user's mobile device's Origin Location and the user's newly extended Perimeter Distance, and to trigger another alarm if the system determines that the user has walked, traveled or otherwise moved beyond this newly extended Perimeter Distance), or the user can choose to pause the alarm (therefore allowing the user to temporarily travel beyond the Perimeter Distance, such that the reminder/alert process will resume when they are back within the area of the Perimeter Distance).

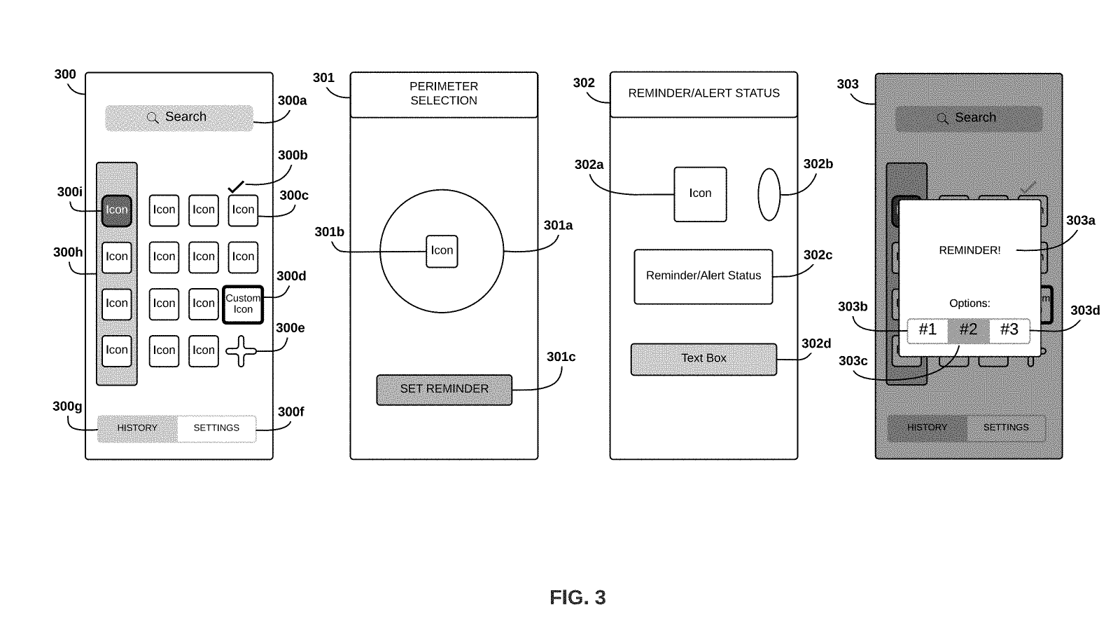

FIG. 3 exemplarily illustrates screenshots showing the steps performed in the process of creating a reminder/alert using the proximity-based reminder system. Initially, when the user first initiates the mobile application implemented method for a proximity-based reminder system, the user is presented with a 300 home display page that is essentially a start page for the mobile application. The 300 home display page has a number of elements providing specified functions for the user, most important of which is a collection of 300c preinstalled icons or graphical representations of personal items that serve as the default list/library of items the user can create a reminder/alert from. These 300c icons will be accompanied by text to name or describe the personal item, and may be arranged in such a way that they constitute multiple pages (e.g. allowing the user to scroll, swipe or otherwise view multiple pages of personal items), and may be arranged alphabetically or sorted based on another method (e.g. based on frequency of use, based on relevance based on user's location, based on user's interaction history with the mobile application, etc.). Integrated within the collection of 300c preinstalled icons will be 300d custom icons generated by the system if/when the user optionally adds personal items to the default list/library, as illustrated in 102 the implementation method. These 300d custom icons will include a graphical representation of the item added (e.g. bold initials of the item name, or similar) along with text added by the user to name or describe the personal item. The user will begin the process of adding 300d custom icons to the default list/library by interacting with 300e a button or interface that allows the user to add an item. This 300e button or interface may include the text, “Add an Item” or provide a similar indication of its purpose. In addition to the library or list/library of 300c icons representing default personal items and 300d custom icons representing user-added items, the 300 home display page will also feature a 300h segmented or highlighted section that will represent personal items that the user has either recently created reminders/alerts for, or has previously added to their list of “favorites” (either manually based on a selection in the settings of the system, or automatically as defined by their past history of creating reminders/alerts). In an embodiment, the proximity-based reminder system may catalog or generate a list of items the user has previously created reminders/alerts for, interpret that data internally, and present that list of items in a highlighted section within the interface (called “recent” or “favorites” or similar). The user can utilize this 300h section to create reminders/alerts from—in the same manner that they would create reminders/alerts from with the default list/library—thereby allowing the user to more quickly create reminders/alerts on items that are most relevant to the user, or that they are most likely to reuse again. This 300h section will be visually distinct from the library of personal items (e.g. through shading, color highlight, or another means of visual separation) and will include personal items that are both 300c icons representing default personal items and 300d custom icons. Additionally, this 300h section may include 300i an icon that allows the user to create a reminder/alert for a generic or non-specified personal item. This functionality allows the user to more quickly create a reminder/alert in instances where time is short, and they do not feel the need to create a reminder/alert based on a specific personal item. This 300i icon will be visually distinct from the 300c icons representing default personal items and 300d custom icons representing user-added items (for example, the design of this 300i icon may connote “speed” or “quick” or utilize a lightning bolt icon or similar), and may include the text, “Quick Alert” or provide a similar indication of its purpose. Additional elements on this 300 home display page include a 300a search interface that allows the user to input the name of an item to narrow down the list/library of 300c icons representing default personal items and 300d custom icons—for the purpose of more quickly finding an item they wish to create a reminder/alert for. The functionality of this 300a search interface is such that the system will dynamically search the name of the default or custom item as the user types or inputs their search query. For example, when the user begins typing “a” in the 300a search interface, all of the default or custom items beginning with the letter “a” will be displayed. As the user inputs more letters or characters, the search output is narrowed. For example, if the user types “s” as the second letter, all of default or custom items beginning with the letters “as” will be displayed, and so on. Additionally, on this 300 home display page will be a 300g button or mechanism for accessing the 108 “history” of reminders/alerts the user has previously created, and a 300f button or mechanism for accessing the “settings” for the system, where the user can customize the reminder/alert notifications, and perform additional personalization and customization functions. Also worth noting, this 300 home display page may also feature a 300b visual indicator that will highlight or otherwise draw attention to a personal item that currently has an active reminder/alert set within the system. This 300b visual indicator will be implemented for both 300c icons representing default personal items and 300d custom icons, and may be represented as a “check” icon, an “alert” icon, a visual highlight (e.g. red border or shading) or similar.

Once the user selects an item from the 300 home display page for the purpose of creating a reminder/alert, the user is presented with the 301 perimeter selection page where the user will indicate the Perimeter Distance for their reminder/alert. This 301 perimeter selection page will prominently feature a 301b graphical representation of the personal item the user selected on the previous 300 home display page (so it is clear which item the user is creating a reminder/alert for). This 301b graphical representation may be unique, or it may be the same 300c icon representing a default personal item or 300d custom icon, although the design and/or color of the 301b graphical representation may match the design/style of this 301 perimeter selection page (e.g. the 301b graphical representation may identical, other than the color and/or size of the 300c icon representing a default personal item or the 300d custom icon). The 301 perimeter selection page will also feature an 301a interactive interface allowing the user to physically increase or decrease the Perimeter Distance (e.g. by way of swiping, stretching, moving or otherwise manipulating the interface). This 301a interactive interface may differ in its design and functionality depending on which movement/distance tracking method is being implemented by the system (e.g. the 301a interactive interface the user is presented with when the system is tracking movement/distance via GPS may be different from the an 301a interactive interface the user is presented with when the system is tracking movement/distance via step count). The 301a interactive interface will also clearly indicate to the user which Perimeter Distance they have selected—whether the Perimeter Distance is reflected via step count, linear distance, and referential distance or otherwise. For example, if the Perimeter Distance is reflected via step count, the 301a interactive interface will indicate to the user how many steps they are selecting (e.g. “20 steps” or “240 steps”). Similarly, if the Perimeter Distance is reflected via referential distance, the 301a interactive interface will indicate to the user what size area they are selecting (e.g. “room” or “city block”). The 301 perimeter selection page also includes a 301c button or interface that allows the user to activate or set the reminder/alert—thereby initiating the 208 creation of an Origin Location, and activating the 104 process of dynamically tracking, mapping and calculating the user's location and movement.

Once the user has set the reminder/alert on the 301 perimeter selection page, the user is presented with the 302 reminder/alert status page where the user can 106 view the status of the reminder/alert in real-time. The 302 reminder/alert status page will prominently feature a 302a graphical representation of the personal item the user initially selected on the 300 home display page (so as to remind the user which item the reminder/alert has been set for). This 302a graphical representation may be unique, or it may be the same 301b graphical representation, although the design and/or color of the 302a graphical representation may match the design/style of this 302 reminder/alert status page (e.g. the 302a graphical representation may identical to the 301b graphical representation, other than in color and/or size). The 302 reminder/alert status page additionally includes 302c an interface for presenting real-time information about the reminder/alert, which may include the details about the Perimeter Distance set by the user, and the current location/movement date of the user, as well as other relevant information about the reminder/alert. For example, the 302c interface may show that the user initially set a Perimeter Distance of 40 steps, in addition to showing that the user has walked 20 steps since the reminder/alert was set. The 302 reminder/alert status page additionally includes a 302b mechanism for the user to cancel and/or modify the current reminder/alert. In an embodiment, cancelling the reminder/alert will terminate the 104 process of dynamically tracking, mapping and calculating the user's location and movement and, in essence, reset the system. In another embodiment, modifying the reminder/alert may allow the user to increase or decrease the size of the Perimeter Distance, or make additional modifications to the reminder/alert (e.g. changing the personal item the reminder/alert was initially set for, etc.). The 302 reminder/alert status page additionally includes a 302d interface for the user to 212 optionally append notes to the reminder/alert that will be presented to the user along with the notification when the alarm is ultimately triggered. This 302d interface will allow the user to use free-form text to type their notes, and may also allow the user to modify and/or delete the notes they have added.

If/when the system calculates that the user's mobile device has moved/traveled beyond the Perimeter Distance (thereby suggesting the user may have walked/traveled away from their personal item beyond the allowable limit), the system will 107 create an alarm in the form of a push notification (or similar notification) and the user will also be presented with a 303 notification overlay to remind them to collect their personal belonging(s) before they leave their location. This 303 notification overlay will include 303a reminder text that mentions the personal item the user initially set the reminder/alert for, and may also include the note(s) the user included using the 302d interface on the 302 reminder/alert status page (if applicable). The 303 notification overlay will present the user with multiple options on how to respond to the 303 notification overlay. The user can choose to 303b cancel the alarm (i.e. to end the process), or the user can choose to 303c extend the Perimeter Distance by a set or custom value of distance or movement (thereby instructing the system to continue to dynamically map and track the user's mobile device's location and movement, and to continue to calculate the difference between the user's mobile device's Origin Location and the user's newly extended Perimeter Distance, and to trigger another alarm if the system determines that the user has walked, traveled or otherwise moved beyond this newly extended Perimeter Distance), or the user can choose to 303d pause the alarm (therefore allowing the user to temporarily travel beyond the Perimeter Distance, such that the reminder/alert process will resume when they are back within the area of the Perimeter Distance).

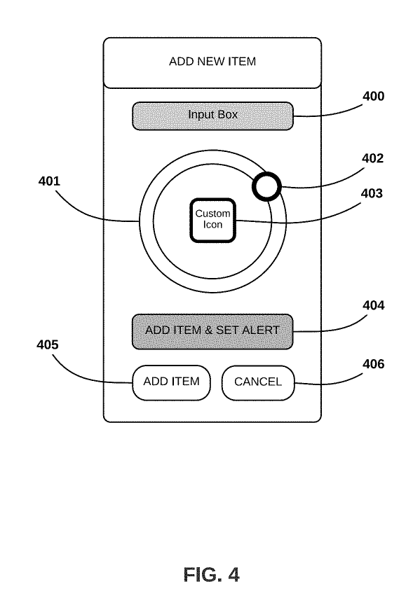

FIG. 4 exemplarily illustrates the “Add New Item” interface, featuring a graphical interface whereby the user can add a custom or personalized item to the default list/library of personal items. The user will be directed to this page if they interact with the 300e button/interface on the 300 home display page that allows the user to add an item. Once on this “Add New Item” display page, the user will be able to interact with a 400 input box where they can type or input a name or short description for the new item they would like to add to the system's list/library of available items. As the user types or inputs the name or description of their item, a 403 custom icon will be dynamically generated to represent this new personal item. The 403 custom icon may be generated from the initials of the name or of the description the user types (e.g. typing “baby food” in the 400 input box may generate a 403 custom icon made from the bold letters “BF”), or the 403 custom icon may be generated in another way to create an easily identifiable representation of the name or description the user inputs in the 400 input box. As a note, the 403 custom icon generated on this “Add New Item” display page may be the same representation as the 300d custom icons displayed on the 300 home display page. As a way to make the new 403 custom icon more visually distinct from the items in the default list/library on the 300 home display page, and as a way to allow the user to add some personalization to their 403 custom icon, the “Add New Item” display page includes a 401 interactive color wheel that allows the user to change the color of the 403 custom icon, or the color of an accent line or border that augments the 403 custom icon (e.g. a thick colored underline between the icon and the text name that identifies the custom item). This 401 interactive color wheel is made up of a collection of different colors, arranged in a circular pattern, and allows for the user to select a color by interacting with a 402 selector or handle by dragging or sliding it around the 401 interactive color wheel. As the user drags the 402 selector or handle around the 401 interactive color wheel, the color of the 403 custom icon (or the color of an accent line or border that augments the 403 custom icon) dynamically changes to match the color that the user has dragged or slid the 402 selector or handle over. Once the user has created a new item, there are several options on how the user can proceed. They can engage a 406 button or interface that allows the user to cancel the process, thereby aborting the “Add New Item” process and returning the user to the 300 home display page. Alternatively, the user can engage a 404 button or interface that allows the user to add the new item to the list/library of default items on the 300 home display page and simultaneously begin the process of creating a reminder/alert (thereby automatically directing the user to the 301 perimeter selection page to continue that process). Alternatively, the user can engage a 405 button or interface that allows the user to add the new item to the list/library of default items on the 300 home display page, and end the “add new Item” process (thereby automatically returning the user to the 300 home display page). As a note, this “Add New Item” display page and graphical interface is created with intelligent software logic such that the user cannot add a new item if the item already exists in the default list/library of items. Similarly, the software logic for this interface may dictate that certain elements are hidden or modified from this display page based on whether a reminder/alert is already active, or based on other user behaviors. In one example, if a reminder/alert is already active, the system may decide not to display the 404 button that would allow the user to simultaneously add an item and set an alert (because a reminder/alert is already set, and a new reminder/alert may therefore create a conflict).

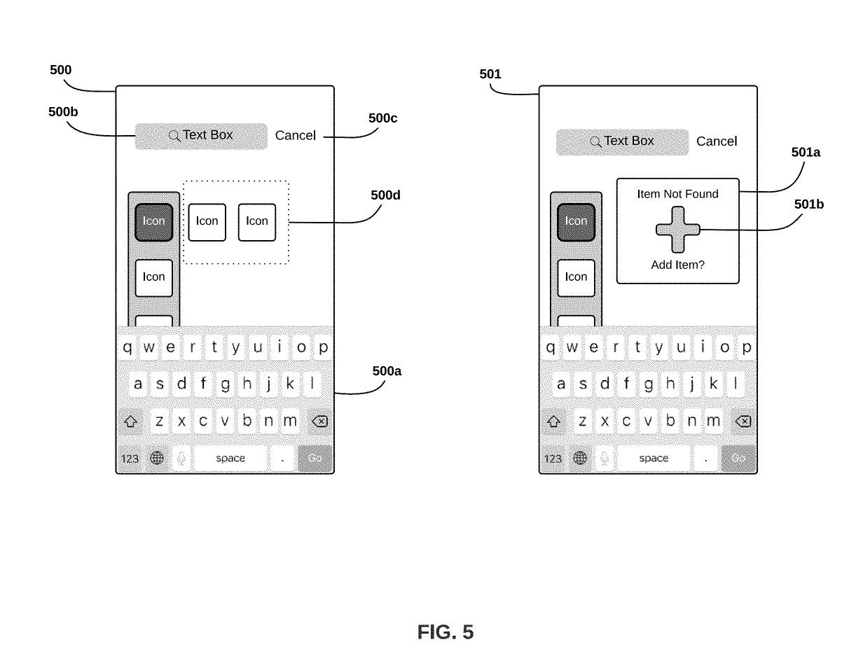

FIG. 5 exemplarily illustrates the “Search” interface that allows the user to quickly find default and custom items in the list/library of personal items. When the user begins to interact with the 300a search interface that is located on the 300 home display page, they will be presented with the 500 search results display page. On this page, the user is presented with a 500a keyboard or other input mechanism (e.g. microphone, etc.) that allows the user to type or otherwise input their search term, item name, or other text into the 500b search bar. As the user inputs their search term, the system will dynamically search the current list/library of default and custom items for a match with the search term. In one example, if the user is searching for “Laptop”, as they type “L” using the 500a keyboard, all of default or custom items beginning with the letter “L” will be displayed in the 500d search results. As the user inputs more letters or characters (e.g. L-a-p), the 500d search results will be narrowed down further to include only the default or custom items that contain the letters the user has typed. This dynamic search allows for faster location of the user's default or custom items, as the user is not required to type or input the entire word, nor is the user required to press (for example) an “enter” button to initiate a search. As a note, the logic of the 500 search results display page and the default item list/library is such that each item may have multiple name values, even though only one name value will be visible to the user. This allows the system to account for users having multiple names for the same item (e.g. to account for slang, dialect, etc.). As one example, the default item “Stroller” may also be identified in the backend of the system as “Buggy” or “Pram”, so if the user searches for “Pram” in the 500b search bar, they are presented with the default item “Stroller” in the 500d search results. At any time, the user can engage a 500c button or interface that allows the user to cancel the process, thereby aborting the search and returning them to the 300 home display page.

If the user inputs a search in the 500b search bar, and the system does not find any items in the default or custom item list/library that matches the search query, the user will be presented with the 501 “item not found” display page. This page may be identical to the 500 search results display page, except the 500d search results will be replaced with a 501a notice or display message that alerts the user that the search returned no results (i.e. the item they were searching for was not found in the default or custom library of items). This 501a notice or display message will include a 501b button or interface that allows the user to add an item to the default library of items, based on the search term they just input in the 500b search bar. If the user engages this 501b button or interface, the system will automatically direct the user to the “Add New Item” display page exemplarily illustrated in FIG. 4, and the search term the user previously input in the 500b search bar will be automatically transposed into the 400 text box on the “Add New Item” display page exemplarily illustrated in FIG. 4, so the user can more quickly add this new item into the default library (i.e. so the user does not need to retype the item name or description they just searched for unsuccessfully).

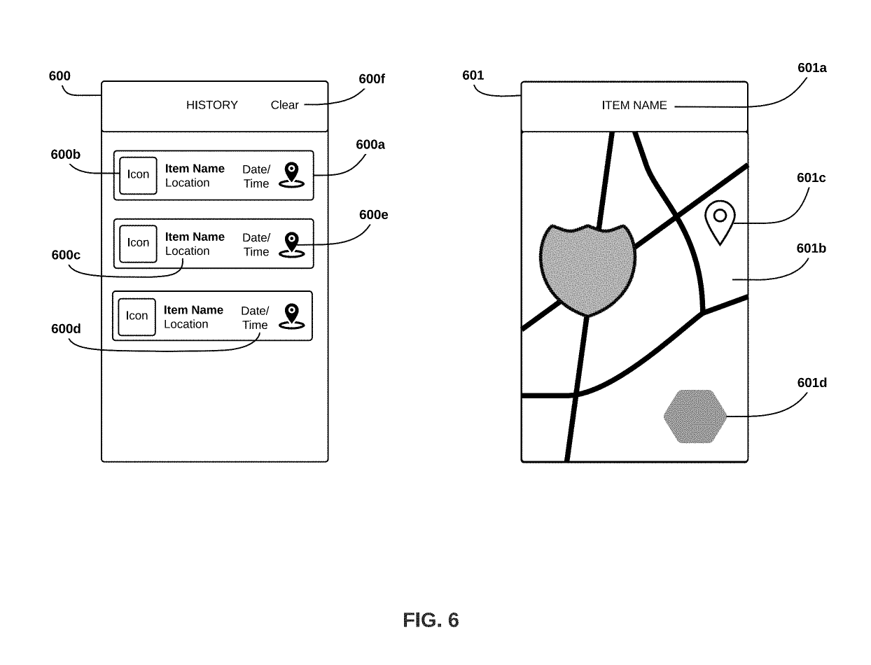

FIG. 6 exemplarily illustrates the “History” interface that catalogs and displays the personal items the user has previously created reminders/alerts for. The user will be directed to this interface if they interact with the 300g button on the 300 home display page. Once the user is directed to the “History” interface, they will be presented with a 600 display page comprising of information from the user's previously created reminder/alerts. This information will be presented in 600a display cards or another graphical representation to contain the information. Information included in these 600a display cards may include the 600b icon or other graphical representation of the item the user previously created a reminder/alert for. As a note, this 600b icon or graphical representation may be unique, or it may be the same 300c icon representing a default personal item or 300d custom icon, although the design and/or color of the 600b icon or graphical representation may match the design/style of this 600 display page. Information included in these 600a display cards may also include the 600c name or description of the personal item, along with the location where the reminder/alert was created. The location may be represented by an address, approximate address, location coordinates, or another representation of the location. Information included in these 600a display cards may also include the 600d date and time when the reminder/alert was created. Information included in these 600a display cards may also include other relevant information about the user's previously created reminder/alerts. The user has the ability to delete individual entries from the 600 display page by way of a long-press, swipe or similar interaction with the 600a display cards, or the user can delete all entries from the 600 display page (thereby deleting their entire history of previously created reminders/alerts) by engaging the 600f button or interface (titled “clear” or “delete all” or similar). For additional benefit to the user, the 600a display cards may include a 600e map icon that allows the user to view the location, on a map, where the reminder/alert was created.

If the user engages the 600e map icon within one of the 600a display cards, they will be directed to a 601 display page featuring a 601b map of the location where that reminder/alert was created. The 601b map will include a 601c marker or indicator or icon to pinpoint or approximate the location on the 601b map where the reminder/alert for the personal item was created. Additionally, there will be a 601d route/directions button or interface that, when engaged, will create a route or list of directions between the user's current location and the location where that reminder/alert was created—to facilitate the recovery of their personal item in the event that the user left the location without bringing their personal item with them. Worth noting, the 601b map will be interactive, such that the user can zoom in/out within the map, and/or pan to different areas within the map. For convenience and reference, the 601 display page will include the 601a item name or description for the personal item that the reminder/alert was created for.

The proximity-based reminder system disclosed herein address the above stated needs for a reminder system that simply and conveniently monitors a user's location (based on the location of the user's mobile device) and the user's proximity to their personal belongings, and reminds the user when they are at risk of leaving those personal belongings behind.

The proximity-based reminder system provides an interface for the user to self-select the personal belongings they intend to keep track of (for the purpose of remembering to take these personal items with them when they leave their current location). This interface includes a pre-determined/default list/library of items for the user to choose from. Further, this interface will allow for the user to temporarily or permanently remove one or more of the items from the default list/library—for the purpose of customizing this list/library to best reflect the personal items they own, and therefore may wish to keep track of.

The proximity-based reminder system provides an interface for the user to add additional items to the default list/library of personal belongings included within the system. Further, this interface allows the user to name or describe their newly added item, and to customize/personalize the look of the newly added item (by way of a custom colored icon or similar) to allow for quicker visual recognition of the user's custom items amongst the default list/library of items. The user can utilize this list/library of custom items to create reminders/alerts from—in the same manner that they would create reminders/alerts from the default list/library.

The proximity-based reminder system provides an interface for the user to select a personal item, and indicate a distance or area that represents an invisible border or perimeter, that, when crossed, will trigger an alarm and/or push notification reminding the user not to leave the area without bringing their personal items with them.

The proximity-based reminder system tracks, maps and calculates the user's dynamic location and movement data from one or more data sources, starting at the location where the user initiates a reminder/alert for their personal belongings (i.e. the Origin Location).

The proximity-based reminder system uses various data sources to determine the optimal method of mapping and/or tracking the user's location and/or movement, including cellular and data connectivity, GPS, Wi-Fi positioning, internal compass, altimeter, pedometer, accelerometer, gyroscope, magnetometer, and/or other data sources.

The proximity-based reminder system includes an interface for allowing the user to view the status of the reminder/alert they have set, along with the functionality to edit and/or cancel the parameters of the alert.

The proximity-based reminder system provides an option for the user to add free-form text notes that will be appended to the alarm notification message when the Perimeter Distance is breached and an alarm is triggered—for the purpose of presenting the user with relevant information to accompany the reminder/alert for their personal belongings.

The proximity-based reminder system creates an alarm, in the form of a push notification, dialog box and/or other type of alarm, to warn the user if/when they have traveled/moved beyond the Perimeter Distance they had initially set.

The proximity-based reminder system catalogs the personal items the user has created reminders/alerts for, for the purpose of learning the user's behavior and anticipating the user's need for creating a reminder/alert in the future.

The proximity-based reminder system collects and logs historical information about the reminders/alerts the user has created, for the purpose of building a list of prior reminders/alerts (i.e. a “history”).

The proximity-based reminder system utilizes the above mentioned historical information collected about the user's previously created reminders/alerts for the purpose of learning and anticipating user behavior, to allow for more convenient, and potentially automatic, creation of reminders/alerts in the future.

The proximity-based reminder system includes an interface to allow the user to customize the audible and tactile aspects of their reminders/alerts, by way of choosing from a library of alert sounds and vibration patterns.

The proximity-based reminder system acquires data about the movement of the user's mobile device, and can differentiate between different states of movement, including standing still, walking, running, driving, and other states of movement. In addition to utilizing this information to determine the optimal method for tracking the user's movement between the Origin Location and the Perimeter Distance (as explained above), the proximity-based reminder system may optionally allow the user to create a reminder/alert while they are walking, running or otherwise in transit to the location that will ultimately become their Origin Location, and the system will automatically suspend the placement of the Origin Location until the user is no longer walking, running or otherwise in transit (i.e. when the system determines the user has arrived at their Origin Location).

The foregoing examples have been provided merely for the purpose of explanation and are in no way to be construed as limiting of the present disclosure outlined herein. While the disclosure has been described with reference to various embodiments, it is understood that the examples are not limited to those precise descriptions and illustrations, and that the words, which have been used herein, are words of description and illustration, rather than words of limitation. Further, although the disclosure has been described herein with reference to particular means, processes, and embodiments, the disclosure is not intended to be limited to the particulars disclosed herein; rather, the disclosure extends to all functionally equivalent, methods and uses, such as are within the scope of the appended claims. Those skilled in the art, having the benefit of the teachings of this specification, may affect numerous modifications thereto and changes may be made without departing from the scope and spirit of the disclosure in its aspects.

I claim:

1. A method comprising:
receiving a first user input identifying one or more items;
receiving a second user input identifying a location of the one or more items;
receiving a third user input identifying a proximity threshold, represented as a maximum allowable travel distance between the location of the one or more items and a location of a mobile device;
determining the location of the mobile device;
periodically calculating a distance between the location of the one or more items and the location of the mobile device;
comparing the proximity threshold to the calculated distance between the location of the one or more items and the location of the mobile device;
determining, based on the comparison of the proximity threshold and the calculated distance, when the mobile device has traveled beyond the proximity threshold; and
generating a reminder when the mobile device has traveled beyond the proximity threshold.

2. The method of claim 1, wherein receiving the first user input includes:
generating an interface with a predetermined list of items; and
allowing the user to select the one or more items from the interface with the predetermined list of items.

3. The method of claim 2, wherein the list of items is generated based on preferences set by the user.

4. The method of claim 2, wherein the list of items is generated based on the user's prior interaction with the list of items.

5. The method of claim 2, wherein the list of items includes items that have been added to the list of items by the user.

6. The method of claim 5, wherein the items that have been added to the list of items by the user include a title or description by the user.

7. The method of claim 5, wherein the one or more items that have been added to the list of items by the user are visually customizable by the user.

8. The method of claim 1, wherein receiving the second user input identifying the location of the one or more items includes receiving a starting location data point.

9. The method of claim 8, further comprising determining which of a plurality of location services on the mobile device has the most accurate location information.

10. The method of claim 8, further comprising switching between a plurality of location services on the mobile device, depending on an availability and reliability of data, to select a location service among the plurality of location services.

11. The method of claim 8, further comprising cataloging item names of the one or more items and starting location data points of the one or more items.

12. The method of claim 11, wherein cataloging the item names of the one or more items and starting location data points of the one or more items includes storing the item names and starting location data points on the mobile device.

13. The method of claim 12, further comprising displaying the item names and starting location data points on the mobile device.

14. The method of claim 1, wherein determining the location of the mobile device includes receiving, from the mobile device, location data.

15. The method of claim 14, wherein determining the location of the mobile device includes determining which of the plurality of location services on the mobile device has the most accurate location information.

16. The method of claim 14, wherein determining the location of the mobile device includes switching between a plurality of location services on the mobile device, depending on the availability and reliability of data provided by each of the plurality of location services.

17. The method of claim 1, further comprising establishing a virtual boundary around the one or more items based on the proximity threshold.

18. The method of claim 1, wherein the process of identifying a proximity threshold includes allowing the user to choose a value that represents how far the user can travel away from the one or more items before the reminder is generated.

19. The method of claim 1, wherein periodically calculating the distance between the location of the one or more items and the location of the mobile device includes periodically determining the differences in location between those locations.

20. The method of claim 19, wherein periodically calculating the distance between the location of the one or more items and the location of the mobile device includes switching between a plurality of movement and location tracking services to determine distance traveled.
